(19) United States
(12) Patent Application Publication
(10) Pub. No.: US 2021/0121892 A1
(43) Pub. Date: Apr. 29, 2021

(54) ROLLER PRESS

(71) Applicant: MASCHINENFABRIK KÖPPERN GMBH & CO. KG, Hattingen (DE)

(72) Inventor: Zdzislaw Andrew GARDULA, Spearwood (AU)

(21) Appl. No.: 17/051,224

(22) PCT Filed: Mar. 14, 2019
(86) PCT No.: PCT/EP2019/056491

§ 371 Date: Oct. 28, 2020

(30) Foreign Application Priority Data
Jun. 6, 2018 (DE) 10 2018 113 440.1

(51) Int. Cl. B02C 4/28; B02C 4/02

(52) U.S. Cl. CPC B02C 4/283; B02C 2210/02; B02C 4/02

(57) ABSTRACT

Roll crusher, in particular for comminuting material, with two rotatable crush rolls (1) forming a nip (2) into which the material to be processed is fed, wherein at axial ends of the rolls the nip (2) is closed by end plates (3), wherein the end plates each comprise a base plate (5) and a wear-protection layer (6) attached to the base plate (5), wherein the wear-protection layer (6) is formed at least in a first wear zone (6a) of individual wear-protection elements that at least partially are made of a wear-resistant material with a hardness greater than that of the base plate (5)

This roll crusher is characterized in that the wear-protection elements in the first wear zone (6a) are formed by studs (9), in that the base plate (5) in the first wear zone (6a) comprises a plurality of individual recesses (10) incorporated in the base plate (5) and in that an individual stud (9) is seated with its entire length (L) into each recess (10) in such a way that the studs (9) do not project past the recesses (10).

The invention relates to a roll crusher with two rotatable crush rolls forming a nip into which the material to be processed is fed, wherein

at axial ends of the rolls (or laterally) the nip is closed by end plates that each comprise a base plate and a wear-protection layer attached to the base plate,

the wear-protection layer is formed at least in a first wear zone (with high stressing) of individual wear-protection elements that (at least partially) are made of wear-resistant material with a greater hardness than that of the base plates.

This roll crusher is intended, in particular, for comminuting material, more particularly strongly abrasive material, for example ore, cement clinker, slag, kimberlite, coal or ceramic raw materials. A roll crusher or this kind for high-pressure comminution is also known as a material bed roll mill. The invention also relates to roll crushers for the compacting or briquetting of material. During the processing of material, for example in comminuting brittle, granular material, high forces always occur and the surfaces of the rolls are strongly stressed so that in practice the wear-protection of the roll surfaces takes on a special significance. Thus, for the wear-protection of the roll surfaces, hard metal studs or knob bolts are used with are embedded in a hedgehog-like manner in corresponding blind holes of the roll body and together with the pressed-in grinding material form an autogenous wear-protection layer (cf. EP 0 516 952 [U.S. Pat. No. 5,269,477]).

However, not only the surfaces of the crush rolls, but also those of the end plates laterally bounding the nip are subject to high stresses and severe wear so that they are provided with a wear-protection layer. In practice such end plates are also known as “cheek plates”. Laterally or on the end face side of the roll they delimit the nip that narrows in a funnel-shape in the direction of rotation of the crush rolls or in direction of conveying. A roll crusher with such lateral cheek plates or ground material guide plates is known from DE 10 2007 032 177 [U.S. Pat. No. 7,997,518] for example.

In practice, in the case of such a cheek plate, for example, a continuous wear-protection layer is applied or fastened to the base plate by way of build-up welding or by other means. Also, in practice it is also known to provide a wear-protection layer made up of individual wear-protection element at least in a first wear zone, which in particular concerns the area of minimal gap width of the nip, in which particularly high forces occur. This can involve a plurality of plate-shaped wear-protection elements (tiles) made, for example, of a wear-resistant composite material, for example hard metal, and fastened in a planar manner in a dense arrangement next to each other on the base plate, for example through soldering. The use of such end plates or cheek plates with a tile-like, wear-resistant surface has thoroughly proven itself in practice. However, in the case of high forces in particularly critical areas the splintering off of individual parts of the tiles can occur and this in turn provides points of attack for further breakouts so that solutions with a tile-like structure are fundamentally ripe for further development. It is here that the invention comes in.

Otherwise, from WO 2014/209417 [US 2016/0129449] a roll crusher with adjustable, lateral limit elements is known. Here, limit elements can also be provided in which stud-like wear-protection elements are arranged in a displaceable manner is sleeve-shaped holders, so that the wear-protection elements are displaceable in the holders in order, for example, to be able to adjust the projection of the wear-protection element past the holder.

The object invention is to create a roll crusher of the type described above in which in the area of the lateral end plates or cheek plates, damage to the wear-protection layer can be reliably prevented. The wear-protection layer in the area of the cheek plates should be characterized by a particularly high durability and consequently optimal wear-protection. Furthermore, such a end plate should be made available.

To attain this object, the invention teaches in the case of a roll crusher of the type described in the introduction that the wear-protection elements are formed by stud-like wear-protection elements and consequently as studs (i.e. wear-protection studs),

that the base plate in the first wear zone comprises a plurality of individual recesses incorporated into the base plate (only open on the front side) and

that into the recesses (or into each recess) one single wear-protection stud is seated with its full length in such a way that the studs do not project above the recesses. Particularly preferably the studs are (essentially) inserted flush into the recesses. This can be done, for example, in that the studs have a length that (essentially) corresponds with the depth of the recesses. Fundamentally it is possible that all recesses have the same depth. However, it is also within the scope of the invention that the recesses have a different depth and in this case it is expedient if the lengths of the studs are matched to the respective depths of the recess so that overall the preferred flush alignment is achieved. Preferably the recesses are separated from one another by webs that fully or partially surround the respective recess. The studs are inserted with their full length into the recesses in such a way that the studs do not project out of the recesses past the webs. It is preferably envisaged that the studs (with their forward surfaces) terminate flush with the webs so that the studs, or their forward surfaces, and the surfaces of the webs form a flush and consequently uniform, flat surface.

The invention is based on the knowledge that the splintering off that may occur in end plates with a tile-like surface can be reliably avoided in a simple manner if a wear layer is made of a plurality of stud-like wear-protection elements, wherein the studs are do not laterally adjoin each other, but are separately completely supported in a plurality of recesses, for example drilled holes, and thereby stabilized. As each individual stud is supported in a single drilled hole over its full extent and full length, there is no danger of splintering off and no points of attack form for further destruction of the surface. Progression of destruction of a single element is therefore reliably prevented through this structure.

In the design of the stud-like wear-protection elements (studs) fundamentally familiar knowledge can be employed. Such wear-protection studs have long been used in practice in the field of roll surfaces of crush rolls for comminuting brittle grinding material. In the area of such roll surfaces it is, however, essentially a matter of the studs protruding past the basic body of the roll, so that through the material to be comminuted an autogenic wear-protection is formed in the intermediate spaces. In contrast to this, according to the invention, in the area of the lateral end plates it is not a matter of forming such an autogenic wear-protection, so that the studs do not project past the surface delimiting them. Through this design according to the invention all bending stresses on the studs are prevented and this in turn results in studs made of particularly hard material being used as they do not have to withstand any bending stresses. Furthermore—as no autogenic wear-protection is being aimed for—a particularly dense arrangement of the studs can be achieved, i.e. the studs are densely arranged with the smallest possible gap between them in order to obtain as extensive a wear-protection layer from these studs as possible. In the case of the lateral end plates according to the invention, the wear-protection studs are thus used on the basis of other considerations and in a different arrangement than in the case of the usual “studlining” surfaces of crush rolls.

The recesses on the one hand and the studs on the other hand are preferably designed cylindrically. The recess can, for example, be in the form of drilled holes or preferably blind holes.

It is advantageous if the base plate is made of a ductile metal, for example steel. Preferably the recesses are directly integrated in one piece into such a base plate, for example through machining, preferably through boring, milling or suchlike.

The wear-protection studs are preferably made of a wear-resistant, multiphase material, for example of hard metal. This involves a nonoxidizing material based on a hard material in the form of an intermetallic (intermediate) phase, consisting of a hard material and a binding phase. Used as hard materials are, in particular, carbides, preferably tungsten carbide (TC) or alternatively also nitrides or borides. Cobalt (Co) is used as the most important binding agent or binding phase. As a rule, in order to product the hard metal studs the powder mixtures of the hard substances, for example carbides, and the binding metal and, if applicable, any organic pressing additives, is pressed and then consolidated, for example through sintering or hot-isostatic pressing. Of particular interest in the context of the invention is that studs of particularly great hardness can be used as, for the already described reasons, the studs are not subject to any bending stresses. Hence, for example, studs made of a hard metal with a particularly low proportion of binding agent, for example a particularly small cobalt portion, can be used. The proportion of binding agent or binding phase, for example the cobalt portion, can, for example, be less than 12% by weight, more particularly less than 10% by weight, for example less than 6% by weight.

In accordance with the invention the stubs are inserted completely into the (preferably exactly matched in diameter) recesses and held in the recess in a form-fitting and/or friction-fitting manner, in that the studs are pressed into the recesses, for example. However, optionally it is possible to also fasten the studs in the recesses in a bonded manner, through adhesion, soldering and/or welding for instance.

The studs are preferably particularly densely arranged on the base plate. Consequently the webs surrounding the recesses and separating the recesses from each other are particularly narrowly designed in the area of minimum thickness. Here, the minimum thickness can be less than half of the diameter of the recesses themselves. The recesses and accordingly also the studs can, for example, have a diameter of 6 mm to 20 mm, for example 10 mm to 20 mm, for example 14 mm to 16 mm. The webs can have a minimum thickness of less than 8 mm, preferably less than 6 mm.

Other than that it is envisaged that the studs, as stud-like wear-protection elements, have a length (for example initial length) that is greater than the diameter of the studs, preferably more than 1.5 times the diameter, for example more than double. The length of the studs is, for example, 10 mm to 50 mm, preferably 20 mm to 40 mm. With a diameter of 10 mm the length can, for example, be 16 mm or with diameter of 35 mm, the length can, for example, be 53 mm.

The recesses, that, for example, are in the form of drilled holes, preferably have a flat or level base. It is also expedient if the studs have a base facing away from the wear surface that is also flat or level.

It is not necessary for the arrangement with recesses and studs according to the invention to be implemented over the entire surface of the end plate. Rather, in a preferred form of embodiment it is envisaged that this arrangement is only restricted to a spatially delimited, first wear zone, which covers the area of the nip with minimal gap width. This can, for example, be a first wear zone with a width of 50 mm to 300 mm, for example 100 mm to 200 mm and with a height of 100 mm to 500 mm, for example 150 mm to 350 mm. Preferably the end plate comprises a second (larger) wear zone that covers the area outside said first wear zone. This second wear zone that in particular covers the area above the first wear zone in the gap widening contrary to the direction of rotation, can, for example, be equipped with conventional wear-protection elements embodied as plate-shaped tiles or with two-dimensional build-up welding. Plate-shaped tiles are taken to mean plate-shaped wear-protection elements, the diameter or width of which is greater than their height or thickness. However, in the second wear zone these tiles are not arranged individually in individual recesses of the base plate. Preferably a base plate produced in one piece is worked with, incorporated into which, by way of machining, for example, are on the one hand one or more planar recesses for the plate-shaped tiles in the area of the second wear zone, and on the other hand a plurality of recesses according to the invention for the studs.

Also within the scope of the invention is the fact for that for the purpose of fastening, the described end plates, which preferably (each) comprise a base plate produced in one piece and the wear-protection layer, are detachably fastened to support plates or assembly plates. In such a roll crusher a support plate is consequently provided laterally of the crush rolls and on the roll face side that is not itself made of wear-proof or wear-resistant material. On these support plates the end plates according to the invention are detachably fasted to the wear layer, for example by means of screws or suchlike. The support plates or assembly plates can preferably be designed to be larger than the actual end plates that form the wear-protection plates.

The subject matter of the invention is also end plate for a roll crusher of the described type. This means that the end plate according to the invention, which is equipped with stud-like wear-protection elements, is also independently protected. All variants and option that are explained in connection with the roll crusher can consequently also be implemented in the case of the protected end plates.

The invention will be described below by way of drawings showing only one form of embodiment. In these

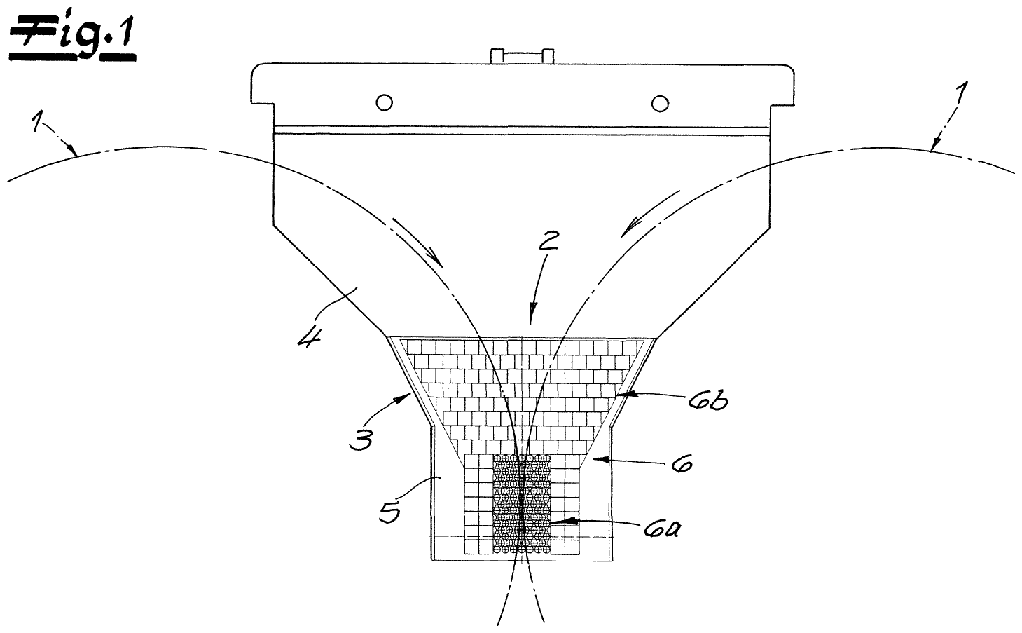

FIG. 1 is a schematic view of a section from a roll crusher in the area of a end plate in a very simplified manner,

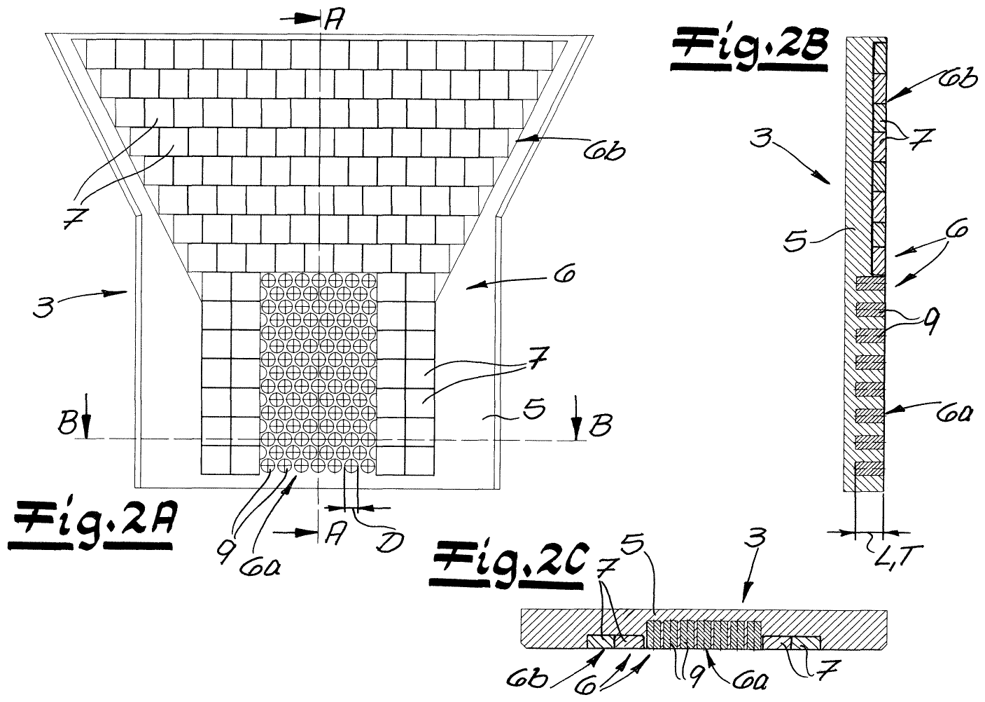

FIG. 2A is a view like FIG. 1 showing an end plate of the roll crusher according to FIG. 1,

FIG. 2B is cross-section A-A from FIG. 2A,

FIG. 2C is cross-section B-B from FIG. 2A,

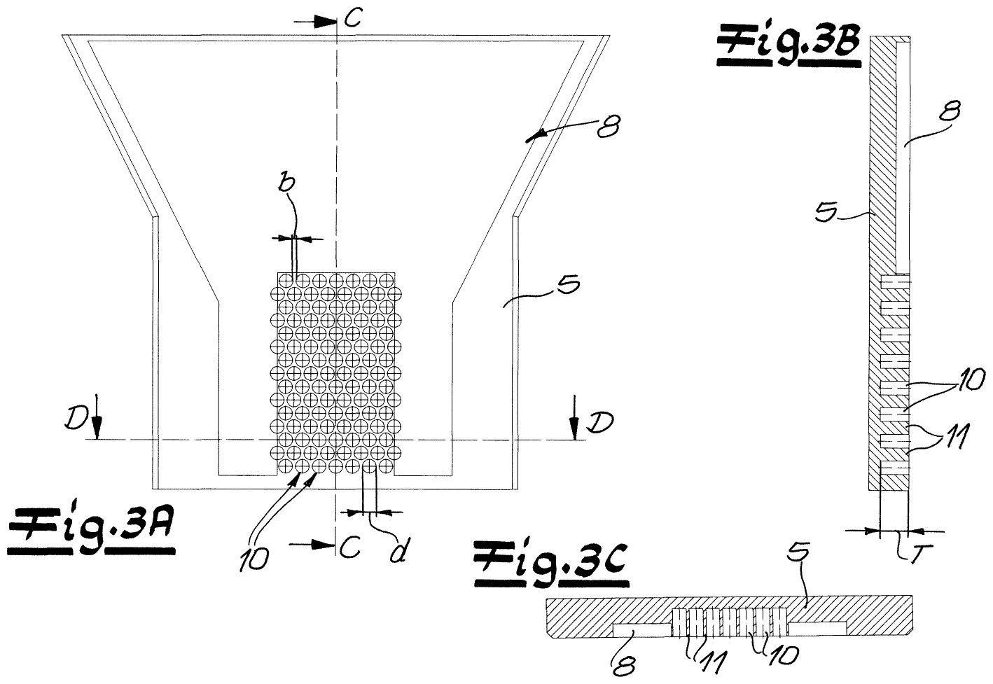

FIG. 3A shows the end plate according to FIG. 2A without wear resistance elements,

FIG. 3B is cross-section C-C through the object according to FIG. 3A and

FIG. 3C is cross-section D-D through the object according to FIG. 3A.

The figures schematically show a very simplified view of the material input area of a roll crusher that can be used, for example, for comminuting material and that is also known as a high-pressure roll crusher or material bed roll mill. The roll crusher comprises two crush rolls 1 that counter rotate in an unillustrated machine frame. The crush rolls 1 are shown schematically. The crush rolls 1 form a nip 2 that narrows like a funnel in the direction of rotation of the rolls. The material to be processed is introduced into this nip 2 from above, for example by a gravity feed or also by a feed auger. Details are not shown, as the invention particularly relates to the end plates 3, which in a roll crusher of this type are at ends of the crush rolls 1 and consequently close the nip 2 at the axial ends of the rolls. In FIG. 1 only one of these end plates 3 is shown fastened on a support plate 4. In turn, these support plates 4 are fastened on the unillustrated machine assembly or machine frame of the roll crusher so that the end plates 3 are exchangeable, since operation of the rolls subjects the end plates 3 to considerable wear. The end plate 3 fastened to the support plate 4 according to FIG. 1 is shown in different views in each of FIGS. 2A, 2B and 2C.

FIGS. 2A, 2B and 2C show that the end plate 3, which in practice is also known as a “cheek plate,” comprises on the one hand a base plate 5 and on the other hand a wear-protection layer 6 attached to the base plate 5. In the area of particularly greatest wear, the wear-protection layer 6 has a first wear zone 6a that in particular covers the area of the minimal gap with of the nip 2 as in this area particularly great forces and hence particularly great stresses with corresponding wear occur. Furthermore the wear-protection layer 6 comprises a second wear zone 6b, which in particular relates to the area above the first wear zone 6a in which the nip widens in a funnel-like manner contrary to the direction of rotation. Also, the second wear zone 6b comprises two outer areas flanking the first wear zone 6a as less wear occurs in these areas as well. In each of the second wear zones 6b the wear-protection layer 6 is formed in a fundamentally known manner of individual wear-protection elements made of a wear-resistant material, designed flat as tiles 7. For this the base plate 5 has a planar recess 8 into which a plurality of such adjoining tiles 7 are inserted so that in the area of the second wear zone 6b a planar wear-protection layer of these tiles 7 is created. These tiles 7 are made for example of hard metal.

However, according to the invention the wear-protection elements in the first wear zones 6a have stud-like wear-protection elements and consequently wear-protection pins or studs 9. These preferably each have a length L that is greater than a diameter D of the stud 9, preferably more than double the diameter D. In addition, the figures show that the base plate 5 in the first wear zone 6a is formed with a plurality of individual recesses 10. Each of these recesses 10 holds a respective one of the studs 9, inserted over their entire length L in such a way that the studs 9 do not project out of the recesses 10, but in this embodiment are flush in the recesses 10. In this embodiment this is achieved in that the length L of the studs (essentially) matches a depth T of the recesses 10. The studs 9 can (also) be made of hard metal. The base plate 5 is made of a ductile metal, for example steel. Preferably the base plate 5 is produced in one piece, i.e. the planar recess 8 as well as the individual recesses 10 are unitarily formed into the base plate, for example by machining. The cylindrical recesses 10 for the studs 9 can be designed, for example, as drilled holes preferably with a flat base.

The design of the base plate 5 is evident particularly by comparison of FIGS. 2A, 2B and 2C with FIGS. 3A, 3B and 3C, as FIGS. 2A, 2B, 2C show the finished end plate 3 with base plate 5 and the wear-protection layer 6 attached thereto. In contrast, FIGS. 3A, 3B and 3C only show the base plate 5 without the wear-protection layer, i.e. without the tiles and the studs.

Particularly FIGS. 3A to 3C show that the recesses 10 in the base plate 5 are separated from each other by webs 11 that each fully or partially circumferentially surround the recesses 10. The studs 9 are now inserted into the recesses 10 in such a way that they do not project past the webs 11 out of the recesses, but the outer end faces of the studs 9 preferably terminate flush with the webs 10 so that in the area of the first wear zone 6a a uniform, flat surface of the wear-protection layer is formed. In addition, it can be seen that the recesses 10 and therefore also the studs 9 are very closely set next to each other, i.e. in the area of their minimum thickness the webs are relatively narrow, having a minimum thickness b that is less than half the diameter d of the recesses 10.

It can also be seen that the tiles 7 and the planar recess 8 are also dimensioned in such a way that the surfaces of the tiles 7 terminate flush with the planar recess 8 or the surrounding of the planar recess 8 and also flush with the studs 9, so that overall a uniform wear-protection layer 6 with an essentially flat surface is formed.

1. In a roll crusher for comminuting material and having two crush rolls rotatable about respective axes and forming an axially extending nip into which the material to be processed is fed and wherein
at axial ends of the rolls the nip is closed axially by end plates having axially confronting plate faces,
the end plates each comprise a base plate and a wear-protection layer attached to the base plate, and
each wear-protection layer is formed at least in a first wear zone of a respective array of individual wear-protection elements at least partially made of a wear-resistant material of greater hardness than the base plate, the improvement wherein
the wear-protection elements in the first wear zone are studs,
the base plate is formed in the first wear zone with an array of recesses each opening at the respective plate face, and
each stud is seated with its entire length into a respective one of the recesses such that the studs do not project outward past the the respective plate face.

2. The roll crusher according to claim 1, wherein the studs are flush in the respective recesses.

3. The roll crusher according to claim 2, wherein a length of the studs is equal to a depth of the recesses.

4. The roll crusher claim 1, wherein the recesses are separated from one another by webs of the base plate and the studs are inserted with their full lengths into the respective recesses such that the studs do not project past the webs out of the recesses, the studs terminating flush with the webs.

5. The roll crusher according to claim 1, wherein the recesses are cylindrical drilled holes and the studs are complementarily cylindrical.

6. The roll crusher according to claim 4, wherein the webs each have a minimum thickness that is less than half a diameter of the respective recess.

7. The roll crusher according to claim 1, wherein the studs have a diameter of 6 mm to 20 mm and the webs have a minimum thickness of less than 8 mm.

8. The roll crusher according to claim 1, wherein the studs inserted into the recesses are also fixed in the recesses by a bond through adhesion, soldering or welding.

9. The roll crusher according to claim 1, wherein the base plates are each produced of ductile steel in one piece by machining.

10. The roll crusher according to claim 1, wherein the wear-protection studs are made of a wear-resistant, multiphase material.

11. The roll crusher according to claim 1, wherein the base plates each comprise a second wear zone that is formed by a planar recess holding a plurality of adjoining wear-protection elements formed by flat tiles.

12. The roll crusher according to claim 1, wherein the end plates are detachably fastened to respective support plates, the support plates with the end plates fastened thereon being fastened to a machine frame of the roll crusher.

13. An end plate for a roll crusher according to claim 1, wherein the wear-protection layer, at least in a first wear zone, is formed of individual wear-protection elements that are made of a wear-resistant material with a hardness greater than that of the base plate, wherein
the wear-protection elements in the first wear zone are formed by stud-like wear-protection elements and consequently as studs,
in the first wear zone the base plate comprises a plurality of individual recesses of a depth formed in the base plate,
each of the recesses holds a respective one of the wear-protection studs with its full length in such a way that the studs do not project out of the recesses and preferably terminate flush with the recesses.
